(19) United States
(12) Patent Application Publication
(10) Pub. No.: US 2003/0061076 A1
(43) Pub. Date: Mar. 27, 2003

(54) Watercraft management system

(76) Inventors: Takashi Okuyama, Hamamatsu (JP); Hitoshi Motose, Hamamatsu (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/254,818

(22) Filed: Sep. 25, 2002

(30) Foreign Application Priority Data
Sep. 26, 2001 (JP) 2001-294964

(51) Int. Cl. G06F 17/60

(52) U.S. Cl. 705/4

(57) ABSTRACT

A management system for watercrafts includes a network. A server is connected to the network. A plurality of terminal computers which belong to customers, dealers and watercraft builders join the network. The server manages warranty condition data of each watercraft. The server collects usage status data regarding each watercraft. The server also determines whether the data are different from the data previously collected. The server further establishes the warranty condition data of each watercrafts based upon the determination.

### PRIORITY INFORMATION

This application is based on and claims priority to Japanese Patent Application No. 2001-294964, filed Sep. 26, 2001, the entire content of which is hereby expressly incorporated by reference.

### BACKGROUND OF THE INVENTION

1. Field of the Invention

The present invention generally relates to a management system for a watercraft, and more particularly to an improved management system for a watercraft using a network.

2. Description of Related Art

Relatively small watercraft such as pleasure boats and fishing boats can employ a propulsion unit such as an outboard motor. The outboard motor typically incorporates an internal combustion engine placed atop thereof and a propeller disposed in a submerged position when the associated watercraft rests on a surface of a body of water. The engine powers the propeller to propel the watercraft.

All watercraft need periodic maintenance to keep components or parts related to the watercraft and/or the outboard drive in good condition. If the watercraft, the propulsion unit or the components thereof are found to be damaged or excessively worn, the owner of the watercraft needs to repair or replace them. However, such repairs or replacements can be expensive for the owner to carry out at his or her own expense.

Currently, watercraft sellers provide warranties on watercrafts which they sell for a predetermined period of time, such as, for example, one year, one and half years, two years, two and half years or three years after selling the watercraft. The warranties typically cover the watercraft, the propulsion unit and components related thereto.

Under such warranties, if any defective or improper condition is found, the watercraft seller will repair the defective portion of the watercraft or the propulsion unit. Otherwise, the watercraft seller will exchange the defective component with a new component. In other words, the watercraft sellers are obliged to guarantee the quality of the watercraft to some extent. Thus, the warranty conditions are one of the most important factors for customers in deciding which watercraft to purchase.

After purchase, some owners moor the watercraft at a marina. Typically, such marinas provide periodic diagnosis and maintenance services on the watercraft left at the marina, although additional fees for such services are usually charged. Such watercraft thus are kept in a relatively good condition and the likelihood of catastrophic failures is reduced.

Other owners transport their watercraft, on a trailer, to their garage, office, or another commercial storage facility. The majority of such owners are more likely to neglect necessary maintenance services, and thus often do not understand the condition of the watercraft and/or the propulsion unit. Occasionally, such owners find a defective component just as they start operating the watercraft in the water and attempt to perform repairs or replacements of the components under the warranty.

As thus described, the conditions of watercraft vary depending on how the watercraft have been treated by the owner after the purchase. However, watercraft sellers presently provide the same warranty conditions uniformly to all customers.

### SUMMARY OF THE INVENTION

One aspect of the present invention includes the realization that a more equitable warranty policy for watercraft and watercraft-related equipment can be provided by utilizing a maintenance database. For example, a watercraft can be provided with a memory for storing maintenance information and a network interface device for transmitting maintenance information over the network. As such, a warranty carrier can maintain a database for storing maintenance information transmitted by users of such watercraft. Additionally, using the maintenance information, the warranty carrier can adjust the terms of the warranties based on the maintenance information stored in the database. For example, but without limitation, a warranty for a particular watercraft can be shortened if the watercraft has not been maintained in accordance with the manufacturer's recommendations. Additionally, a warranty may be extended based on better compliance with the manufacturer's recommendations.

In accordance with another aspect of the present invention, a warranty management system is provide for watercraft having a propulsion device and a plurality of sensors configured to detect operational states of the propulsion device. The system comprises a controller configured to collect operational data from the sensors, wherein the controller comprises a memory for storing the operational data as well as maintenance data entered from an owner of the watercraft and maintenance data entered by a professional maintenance service provider. The system also includes a server. A communication device is configured to transmit all of the stored data to the server. The server is configured to store the data from the controller and to adjust a warranty covering the watercraft based on the data from the controller.

In accordance with an additional aspect of the present invention, a management system for a watercraft comprises a network, a plurality of terminal computers joining the network, and a data collecting apparatus. The data collecting apparatus is configured to collect usage status data regarding the watercraft and to provide the network with the data. The data is available at at least one of the terminal computers.

In accordance with a further aspect of the present invention, a management system for a plurality of watercraft comprises a network, a host computer connected to the network, and a plurality of terminal computers connected to the network. The host computer manages service condition data of each one of the watercraft. The host computer collects fundamental data regarding each one of the watercraft and determines whether the fundamental data are different from fundamental data previously collected. The host computer also establishes the service condition data of each one of the watercraft based upon the determination.

In accordance with a yet another aspect of the present invention, a method is provided for managing data regarding a watercraft. The method comprises collecting data regarding the watercraft, providing a network with the data, accumulating the data at a host computer connected to the network, and selectively authorizing access to a user at a terminal computer connected to the network.

In accordance with a still further aspect of the present invention, a method for managing data regarding a plurality of watercraft is provided. The method comprises collecting fundamental data regarding each one of the watercraft at a host computer connected to a network, determining whether the fundamental data are different from fundamental data previously collected, and establishing service condition data of each one of the watercraft based upon the determination.

### BRIEF DESCRIPTION OF THE DRAWINGS

These and other features, aspects and advantages of the present invention will now be described with reference to the drawings of a preferred embodiment, which is intended to illustrate and not to limit the invention. The drawings comprise seven figures.

FIG. 1 is a schematic view of a management system for a watercraft configured in accordance with certain features, aspects and advantages of the present invention.

FIG. 2 is a schematic view of a watercraft and an outboard drive associated with the watercraft which together have an intranet system that can be applied to the management system of FIG. 1. Generally, the watercraft and the outboard motor are illustrated in phantom except for the intranet system.

FIG. 3 is a block diagram showing the intranet system of FIG. 2.

FIG. 4 is a table for operational status data of the watercraft and the outboard drive.

FIG. 5 is another table for maintenance data regarding maintenance services performed by the owner on the watercraft.

FIG. 6 is a further table for maintenance data regarding maintenance services performed by a maintenance service professional.

FIG. 7 is a flow chart illustrating a routine that can be performed by the management system of FIG. 1.

### DETAILED DESCRIPTION OF THE PREFERRED EMBODIMENTS OF THE INVENTION

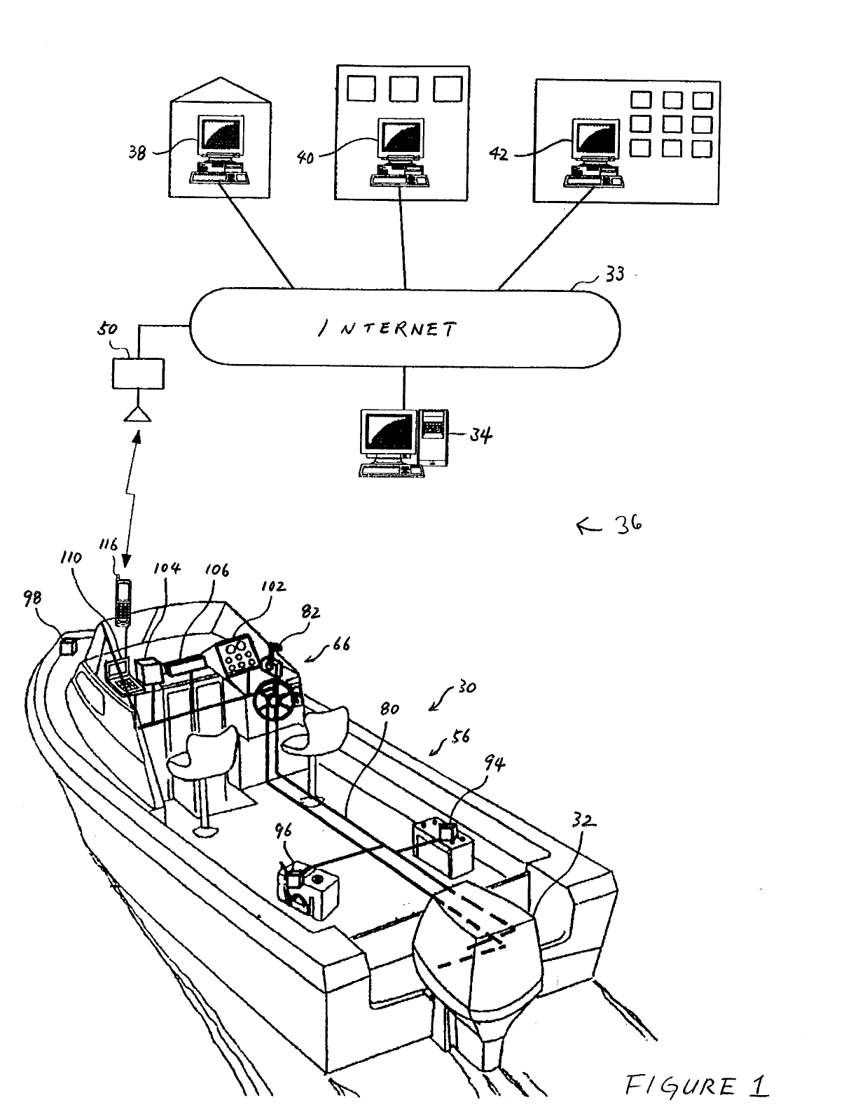

With reference to FIG. 1, a relatively small watercraft 30, such as a pleasure boat or a fishing boat is provided with a propulsion unit in the form of an outboard drive 32. In the illustrated embodiment, the outboard drive 32 is an outboard motor mounted on a transom of the watercraft 30 for propelling the watercraft 30. Typically, the outboard motor 32 is detachable from the transom. In general, a customer or purchaser of a watercraft can select any one of the outboard drives sold on the market. The customer normally purchases the watercraft through a dealer. The dealer requests a watercraft builder to combine the outboard drive, which was selected by the customer, with the watercraft. Occasionally, the dealer sells either the watercraft or the outboard drive separately. The dealer also sells components or parts of the watercraft and/or the outboard drive.

A watercraft seller provides the customer with a warranty on the watercraft 30 upon the purchase of the watercraft 30. The watercraft seller is a company which sells watercraft to customers through the dealer. For instance, the watercraft seller can be a supervisory company which controls a number of dealers and several watercraft builders. However, the term “watercraft seller” in this description can include the dealers, the watercraft builders who sell watercraft, and other companies or persons who sell watercraft to customers directly or indirectly. The warranty normally covers both the watercraft 30 and the outboard drive 32. The warranty can be provided inclusively on both the watercraft 30 and the outboard drive 32, or separately for the watercraft 30 or the outboard drive 32. The warranty also can be provided on each device, unit, or component of the watercraft 30 or outboard drive 32.

A management system 36 configured in accordance with certain features, aspects and advantages of the present invention, manages a warranty provided to a customer based on the manner of operation and/or the maintenance performed on the watercraft and/or the propulsion unit by the customer. The management system 36 has a particular utility in the context of the management of the small watercraft 30 combined with the outboard drive 32 and is described in the context of such a combination. The management system 36, however, can be used for other types of watercraft. For example, the management system 36 can be applied to a watercraft with an inboard motor or inboard motor/outboard drive. In addition, the management system 36 is also practical for personal watercraft equipped with a jet pump.

With continued reference to FIG. 1, the management system 36 comprises a network to which a host computer, a number of terminal computers and a communication device are connected. In the illustrated embodiment, the Internet 33 is used as the network. The Internet 33 provides large numbers of sites where users can browse information, data, and software at the users' choice.

A server 34 is connected to the Internet 33, and in the illustrated embodiment, serves as a host computer. The server 34 is installed with a program which includes a warranty management routine, a web server program, and other programs for controlling the management system 36. In accordance with the warranty management program, the server 34 manages data collected from the watercraft 30 in relation to the warranty on the watercraft 30. Although the management system 36 is described herein as managing one warranty for one watercraft, the system 36 can be scaled to handle a large number of warranties on one, or a large number of different watercraft owned by one or a large number of different owners. In accordance with the web server program, the server 34 provides the status data and information as to the warranty at the Internet site.

The server 34 preferably is placed at a control entity which controls the management system 36. The control entity can be the watercraft seller such as the supervisory company, the dealer, or the watercraft builder. Otherwise, an entity other than the watercraft seller, such as, for example, an ASP (application service provider) can be the control entity.

The customer, the dealer, and the watercraft builder have their own terminal computers 38, 40, 42. The terminal computers 38, 40, 42 join the Internet 33 through circuits or lines such as, for example, a telephone circuit and ADSL (asymmetric digital subscriber line). An all-purpose browser program is installed in each terminal computer 38, 40, 42.

In order to access the data or information including the warranties provided by the server 34, the customer, the dealer, and the watercraft builder can adopt an agreement with the entity who controls the management system 36. The control entity preferably gives a user ID and a password to each customer, dealer, and watercraft builder upon completion of the agreement, allowing these parties to access the server 34 as authorized users. The user contacts the site of the management system 36 on the Internet 33 with the user ID and the password. The user, then, is authenticated as an authorized user by the server 34 and can access information or data at the site.

The management system 36 also preferably comprises at least one data collecting device disposed on the watercraft 30. A radio receiver or radio base station 50 communicates with a communication device at the watercraft 30 to receive data collected by the data collecting device of the watercraft 30 and to provide the server 34 with the data.

Preferably, the watercraft 30 and the outboard drive 32 are connected through an infrastructure including an intranet system 56 which connects controllers, sensors, indicators, and other electrical devices in the watercraft 30 and the outboard drive 32. The Intranet system 56 includes data collecting system, which is described greater detail below.

The data collecting system preferably is configured to collect operational status data, which are at least related to the operation of the outboard drive 32 and part of the usage status data, through the intranet system 56. For example, the data collection system can collect such each time the outboard drive 32 is shut down.

The data collecting system also preferably collects maintenance data, which is part of the usage status data. Normally, maintenance data are input by the owner, operator, mechanic, repairperson, or someone else who has conducted a maintenance service on the watercraft 30 and/or the outboard drive 32. The collected data are sent to the radio receiver 50 through the communication device at the watercraft 30, which is also described in greater detail below. The collected data, i.e., the usage status data, can be used by the server 34 to manage, e.g., adjust warranty coverage of the specific watercraft and/or outboard drives.

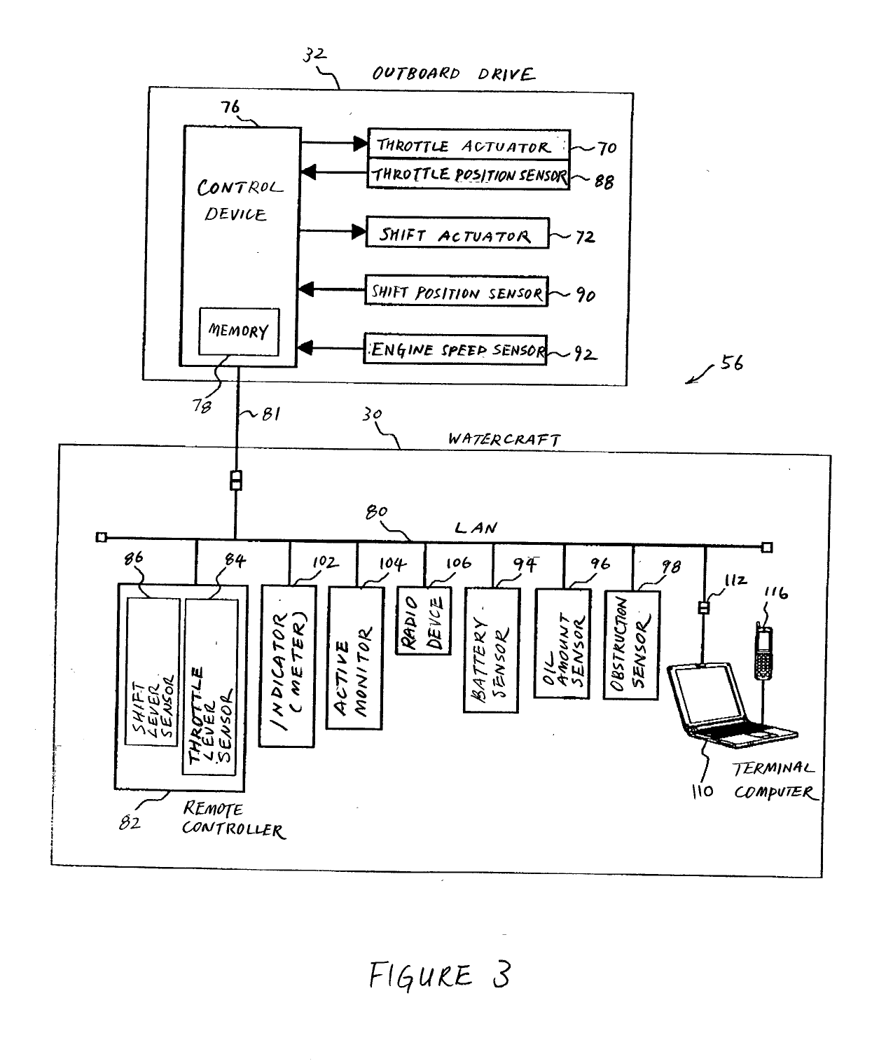

With reference to FIGS. 1-3, the watercraft 30, the outboard drive 32 and the infrastructure including the intranet system 56 is described in greater detail below.

The outboard drive 32, i.e., outboard motor in this embodiment, incorporates an internal combustion engine 64 that is disposed atop of the outboard drive 32 and a propulsion device (not shown) such as, for example, a propeller that can be placed in a submerged position when the watercraft 30 rests on a surface of a body of water. The engine 64 powers the propeller to propel the watercraft 30. The engine 64 and the propulsion device together define the propulsion unit. The watercraft 30 defines a cockpit 66 in which the operator remotely operates the outboard drive 32.

The engine 64 comprises an air induction system that guides air to one or more combustion chambers of the engine 64. The engine 64 additionally comprises a charge forming system such as a fuel injection system or carburetor system associated with the air induction system to form air/fuel charges in the combustion chambers. When the air/fuel charges burn in the combustion chambers, power is generated. The outboard drive 32 uses the power to drive the propeller. An exhaust system also is provided to guide byproducts from the combustion chambers.

The air induction system incorporates a throttle device or mechanism comprising one or more throttle valves (not shown) to regulate or meter an amount of air moving therethrough. Each throttle valve can be a butterfly type and can be coupled with an intake passage or a plenum chamber for pivotal movement. When the position of the throttle valve is changed, an opening degree of an airflow path of the intake passage or the plenum chamber changes and an amount of the air can be regulated. Thereby, the output of the engine 64 can be changed. Normally, the greater the opening degree, the higher the rate of airflow and higher the power output. A slidably movable throttle valve of course can replace the butterfly type throttle valve.

The throttle device preferably is provided with a throttle actuator 70 such as, for example, an electric motor. The electric motor preferably is coupled with a throttle valve shaft or a shaft related to the throttle valve. The electric motor is configured to change the opening degree of the throttle valve in response to a control signal to actuate the throttle device. Thus the electric motor and the throttle valve assembly can define an electronic throttle control system (e.g., an EGAS system) that responds to the request signal (e.g., a torque request).

The output of the engine 64 is transferred to the propeller through a transmission disposed in a lower housing of the outboard drive 32. The transmission has a shift mechanism that can change a state of the transmission between forward, neutral and reverse. Through this description, the term “gear position” means the state of the transmission or the position of the shift mechanism that corresponds to the direction in which the propeller is driven.

The shift mechanism preferably is provided with a shift actuator 72 such as, for example, an electric motor or a solenoid coupled with a shift rod or other members of the shift mechanism. The motor or solenoid moves in response to a control signal to actuate the shift mechanism.

The outboard drive 32 incorporates a control device 76 that controls the throttle actuator 70 and the shift actuator 72 in this embodiment. The control device 76 preferably comprises a microprocessor or central processing unit (CPU), a memory or storage device 78, and an interface connecting the CPU and the memory to each other. It is apparent to one of ordinary skill in the art that the control device 76 can be in the form of one or a plurality of general purpose processors and memory storing one or a plurality of computer programs for performing the functions described below, one or a plurality of dedicated processors and memory for running one or a plurality of programs for performing the functions described below, one or a plurality of hard-wired electronic modules configured to perform the functions described below, or hybrid system including at least two of a general purpose processor, a dedicated processor, and a hard-wired module.

The illustrated control device 76 is located next to the engine 64. Other locations also are available. For example, the control device 76 can be placed in a hull of the watercraft 30. The illustrated control device 76 defines part of the data collecting system.

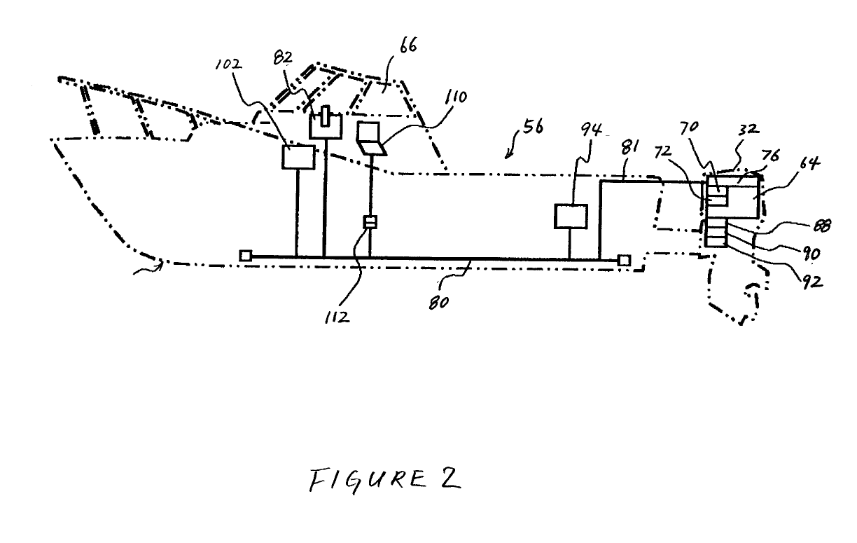

With reference to FIGS. 1-3, the watercraft 30 is provided with a remote helm device 82 (FIGS. 1 and 2) preferably disposed at the cockpit 66. A local area net work (LAN) 80 and an electric cable 81 preferably connects the remote helm device 82 with the control device 76. The LAN 80 can be furnished at the bottom portion of the hull along the keel line extending fore to aft.

The remote helm device 82 preferably includes a pair of levers (not shown) pivotally or slidably mounted onto a body of the device 82. One of the levers is a throttle lever communicating with a throttle position sensor 84 and the other lever is a shift lever communicating with a shift position sensor 86. Preferably, the throttle and shift levers are positioned adjacent to each other such that the operator can operate both of the levers with one hand.

The sensors 84, 86 are configured to detect a position of the throttle lever and shift levers, respectively, and generate a signal indicative of these positions. The signal can have a voltage or other electrical value. Preferably, the sensors 84, 86 and/or the remote device 82, converts the position of the throttle and shift levers into digital signals. Additionally, the sensors 84, 86, and/or the remote helm device 82 formats the digital signals appropriately for transmission over the LAN 80 in accordance with the networking protocol in operation therein.

When the throttle lever is operated, the throttle lever sensor 84 generates a throttle position request signal. When the shift lever is operated, the shift position setter 86 generates a shift position request signal. In other words, an amount of the physical movement of either the throttle lever or the shift lever, i.e., an angular position or a slide position from each original position, is converted to a signal that has a voltage or other electrical values, and preferably a digital signal formatted in accordance with the protocol operating on the LAN 80.

Preferably, a throttle position sensor 88, a shift position sensor 90 and an engine speed sensor 92 are configured to detect and generate a signal indicative of the position of the throttle valve, the gear position of the transmission, and a speed of the engine. Each of the sensors 88, 90, and 92 are connected to the control device 76 with communication lines. Each signal has a voltage or other electrical values.

Preferably, the throttle position sensor 88 is configured to detect an actual position or opening degree of the throttle valves. The throttle position sensor 88 preferably is disposed on a valve shaft or a shaft connected to the valve shaft.

The shift position sensor 90 is configured to detect an actual position of the transmission shift mechanism. That is, the shift position sensor 90 senses whether the propeller position is at the forward, neutral or reverse. The shift position sensor 90 can be disposed, for example, adjacent to the shift rod.

The engine speed sensor 92 preferably is formed with a crankshaft angle position sensor which is provided proximate a crankshaft of the engine 64. The angle position sensor, when measuring crankshaft angle versus time, outputs a crankshaft rotational speed signal or engine speed signal. Alternatively, the crankshaft angle position sensor can be configured to output a stream of pulses corresponding to the movement of teeth on the periphery of a flywheel attached to the crankshaft of the engine. The frequency of the pulses can be used by the controller 76 to determine the speed of the engine.

The CPU of the control device 76 can recognize the engine load from the throttle position signal and the engine speed signal and uses the engine load in controlling the outboard drive 32 and particularly the engine 64.

The control device 76 can be configured to send the request signals from the sensors 84, 86 to the throttle actuator 70 and the shift actuator 72 without modification. However, more preferably, the illustrated control device 76 analyzes the initial request signals in light of current operational conditions of the engine. For example, the control device 76 can compare the request signals with a multi-dimensional control map, such as, for example, but without limitation, a three-dimensional map, stored in the memory 78 which includes more preferable control amounts for controlling the throttle and shift actuators 70, 72 according to engine loads and throttle lever positions. The multi-dimensional map can be determined through experimentation and/or be derived in accordance with any known control strategy.

In operation, the CPU within the control device 76 communicates with the memory 78 through the interface. Then, in accordance with the data in the multi-dimensional map, control amounts are selected based on the request signals from the remote helm device 82 and the data regarding engine modes and throttle lever positions within the control map. These control amounts, which can be different from the corresponding request signals, are used to control the throttle and shift actuator 70, 72.

A similar control system is disclosed in a co-pending U.S. application, titled ENGINE CONTROL SYSTEM FOR WATERCRAFT, which attorney's docket number is FS.20063USOA, entire contents of which is hereby expressly incorporated by reference.

In the illustrated embodiment, the watercraft 30 also includes a battery charge capacity (i.e., battery voltage) sensor 94, a lubricant oil amount sensor 96 and an obstruction sensor 98. The battery charge capacity sensor 94 is configured to detect changes in the battery voltage. The lubricant oil amount sensor 96 is configured to detect whether the oil amount is greater than a preset amount. The obstruction sensor 98 is configured to detect whether an obstruction is in front of the watercraft 30.

Other various sensors 66 can also be provided. For example, the other sensors can include a fuel amount sensor, a battery liquid amount sensor, a lubricant oil quality sensor that detects deterioration of the lubricant oil, a conduction sensor that detects electrical conductivity, a usage time integrating sensor or meter that integrates usage time of respective equipped components, a watercraft velocity sensor that detects a velocity of the watercraft 30 relative to a body of the water, a shock sensor such as an acceleration sensor, and a watercraft position sensor that detects a position of the watercraft 30.

Output signals of the sensors 94, 96, 98 and other sensors can be sent to the LAN 80 directly or through the control device 76 and/or the electric cable 81. Some of the output signals are used for control of the outboard drive 32.

In this description, the term “sensor(s)” means not only the sensors in the narrow sense but also parts, components, devices and other equipment that can output a condition thereof by themselves. For example, the control device 76 in this embodiment is one of the sensors in the broad sense because the control device 76 is aware of the conditions of the throttle and shift actuators 70, 72. Furthermore, the sensors can include the throttle and shift actuators 70, 72 if these actuators send signals indicative of the condition thereof without the control device. The conditions of the throttle and shift actuators 70, 72 that the control device 76 knows form control data of those actuators 70, 72. The operational status data include the control data.

Additionally, it is clear to one of ordinary skill in the art that the sensors that are connected directly to the LAN 80 can be configured to generate analog or digital signals. Where analog signals are generated, the sensors can include an analog-to-digital converter. Additionally, each of the sensors can include a network interface device for formatting the digital signals into a format appropriate for the network protocol operating on the LAN 80. Alternatively, each of the devices 82, 84, 86, 94, 96, 98, 102, 104, 106 can be connected to a single network interface device for formatting signals therefrom into the appropriate format for communication over the LAN 80.

Extending between the hull of the watercraft 30 and the outboard drive 32 are other electric cables such as, for example, a power cable from the battery disposed in the hull and conduits such as, for example, a lubricant delivery conduit and a fuel delivery conduit. Those cables and conduits are omitted in FIGS. 1-3.

A digital or analog indicator (or meter) 102 also is disposed at the cockpit 66 and is connected to the LAN 80 to indicate the throttle position, the shift position, the engine speed, the battery voltage, the lubricant oil amount, the presence of an obstruction, and other necessary or preferable data. Such additional data can include the watercraft velocity, mileage, present time, engine operational time, a trim angle of the outboard drive, an oil pressure and abnormal warnings (e.g., overheat or abnormal engine operation).

In the illustrated embodiment, an active monitor 104 and a radio communications unit 106 also are provided at the cock pit 66. The active monitor 104 can display engine-related information, fish-finding information, position information by GPS (Global Positioning System), navigation-related information and other information or data that are not indicated at the indicator 102. The radio communications unit 106 is another communication device using a VHF radio system or a satellite radio system. Other devices can be equipped.

Preferably, a terminal computer 110 is detachably connected to the LAN 80 through a connector 112. The illustrated computer 110 is an all-purpose computer such as, for example, a personal laptop-type computer that has a keyboard and a monitor. Preferably, the computer 110 also includes other input units such as a floppy disc drive and/or a compact disc drive. The owner or operator can input any data through the input units of the computer 110. The computer 110 can also collect any data available at or through the LAN 80. The illustrated computer 110 thus can define a part of the data collecting apparatus.

A cellular phone 116 can also be connected to the computer 110. The illustrated cellular phone 116 forms the communication device at the watercraft 30. Other communication devices such as a radio transmitter can be used in place of the cellular phone 116.

The illustrated control device 76 is configured to output the operational status data based upon the conditions of the throttle and shift actuators 70, 72 and outputs of the sensors 94, 96, 98 which are available through the LAN 80. Preferably, the control device 76 is configured to save the data such as, for example, but without limitation, immediately after the engine operation ceases or when the operator instructs the control device 76 to create the data through the keyboard of the terminal computer 110. The operational status data can include a mean value of the engine speeds during a period of operation, the maximum engine speed, the lubricant amount, the battery voltage, conditions of the throttle and shift actuators 70, 72, etc. The mean value of the engine speeds can be calculated by the control device 76 based upon the engine speed data. The operational status data preferably is stored at the memory 78 of the control device 76.

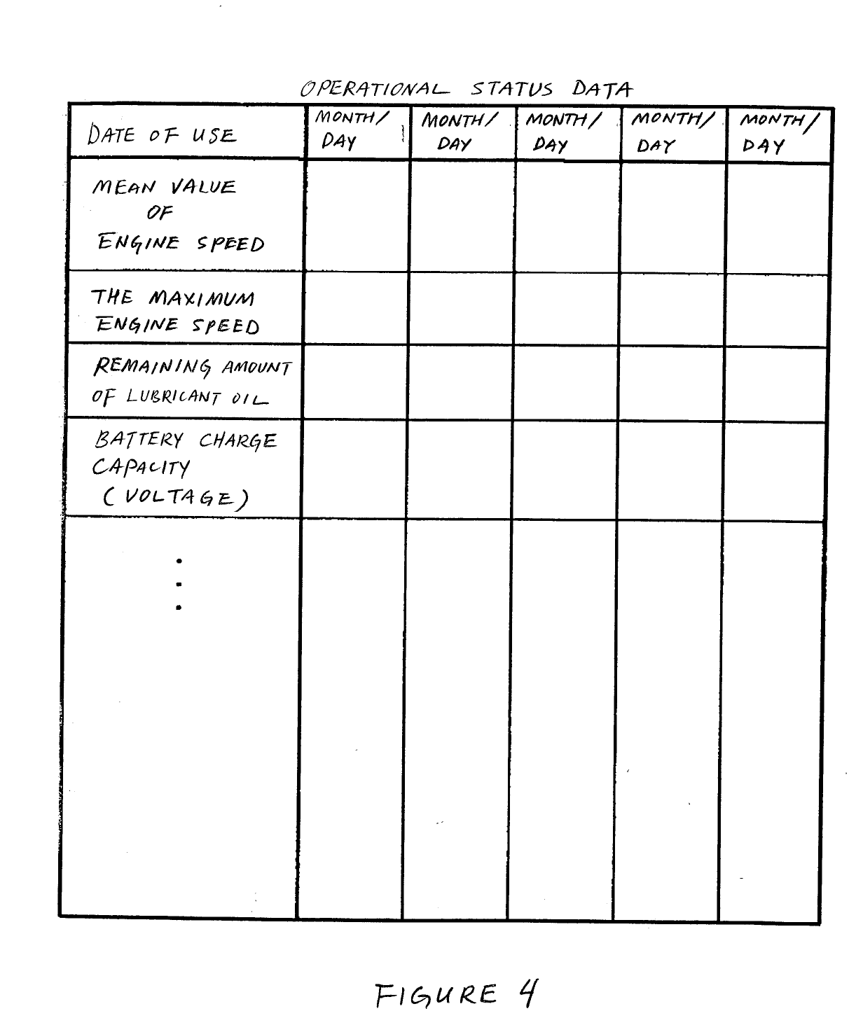

FIG. 4 illustrates an exemplary table for listing the operational status data. The table is formatted for storing data on a daily basis. Alternatively, the table can be formatted for storing data whenever a period of operation ends or whenever the operator chooses.

All watercraft, including the watercraft 30, need periodic maintenance including service on some of the components of an associated propulsion unit, such as the outboard drive 32 and some of the components of the watercraft 30. The components include fuel, lubricant oil, coolant, battery liquid, filters, and other expendables. The recommended maintenance procedures usually include inspections, cleanings, replacement, and replenishment of the components. The components that need to be serviced preferably are predetermined. For example, the owner should inspect fuel supply related components and the propeller. Also, the owner should exchange engine oil.

The data collection system preferably is configured to allow an owner or operator to input data regarding each maintenance service into the computer 110 through the keyboard or other input unit such as, for example, a floppy or compact disc drive. The inputted data defines maintenance data. The date when the maintenance service is performed preferably is included in the maintenance data. The maintenance data preferably are forwarded to the control device 76 through the LAN 80 and are stored in the memory 78 with the operational status data. The maintenance data can be additionally or tentatively kept at the computer 110 if the memory capacity of the computer 110 is sufficient.

FIG. 5 illustrates an exemplary table listing the maintenance data stored in the control device 76 or the computer 110.

Occasionally, a watercraft, such as the watercraft 30, will require relatively more sophisticated maintenance procedures that are usually performed by a professional maintenance service provider such as a mechanic or the dealer from the which the watercraft was purchased. This type of service usually covers a wider range of components than those components that are serviced by the owner. This maintenance service also includes inspections, cleanings, exchanges and replenishment of certain components. The components that need to be addressed for this type of service preferably are predetermined. For example, a professional maintenance service provider should, for example but without limitation, inspect an oil pump, a timing chain, a throttle link and a shift cable. Additionally, the service provider should exchange an oil filter, at which time the oil should also be replaced.

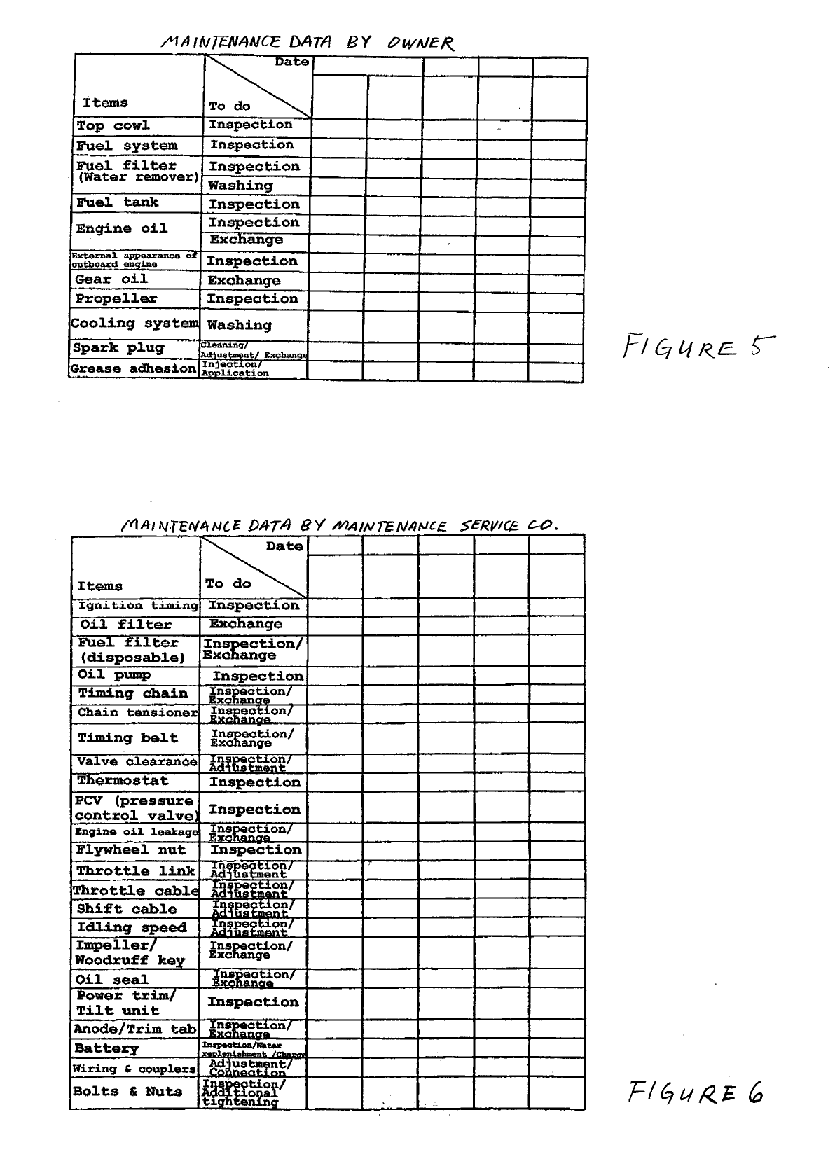

The service provider inputs each service performed into the computer 110 through the keyboard or other input devices such as, for example, the floppy or compact disc drive. This data can be stored separately from the maintenance regarding services performed by the owner described above with reference to FIG. 5. For example, as shown in FIG. 6, the maintenance data entered by the professional maintenance service provider can be stored in a separate form, which is similar to the form illustrated in FIG. 5.

With reference to FIG. 6, the date when the service is performed preferably is included in this maintenance data. The maintenance data preferably are forwarded to the control device 76 through the LAN 80 and are stored in the memory 78 with the operational status data and the maintenance data input by the owner. The maintenance data input by the maintenance service company can also be stored at the computer 110 if the memory capacity of the terminal computer 110 is sufficient.

Otherwise, the service person can store the maintenance data at another computer (not shown) which is connected to the Internet 33. In this alternative, the maintenance data is sent to the server 34 from this computer.

As described above, the operational status data, the maintenance data input by the owner and the maintenance data input by the maintenance service company together form the usage status data. In the illustrated embodiment, the memory 78 of the illustrated control device 76 holds a usage status database comprising the usage status data. Other memory devices such as a separate hard disc memory device or an exclusiveuse computer for this purpose can be used to create and maintain the usage status database.

As described above, the usage status data are used as the fundamental data of the watercraft 30 in the illustrated embodiment. The usage status data can be forwarded to the computer 110 from the control device 76 at any time through the LAN 80. For instance, the usage status data can be forwarded to the computer 110 at a preset time programmed in the computer 110. Optionally, the owner or operator can instruct the control device 76 through the computer 110 to forward the data. Then, the data forwarded to the computer 110 are sent to the server 34 through the cellular phone 116, the radio receiver 50 and the network 33. Optionally, the time at which the data is sent from the cellular phone 116 can be selected by the owner or operator. For example, the time at which data is sent over the cellular phone 116 can be delayed by a particular amount of time after the data was forwarded from the control device 76 to the computer 110.

Preferably, the data collection system 36 is configured to display the data being transmitted to the server 32 on the monitor of the computer 110. Optionally, the data collection system 36 can be configured to allow an owner or operator to view the usage status data or the maintenance data stored in the control device 76 or the computer 110 at any time.

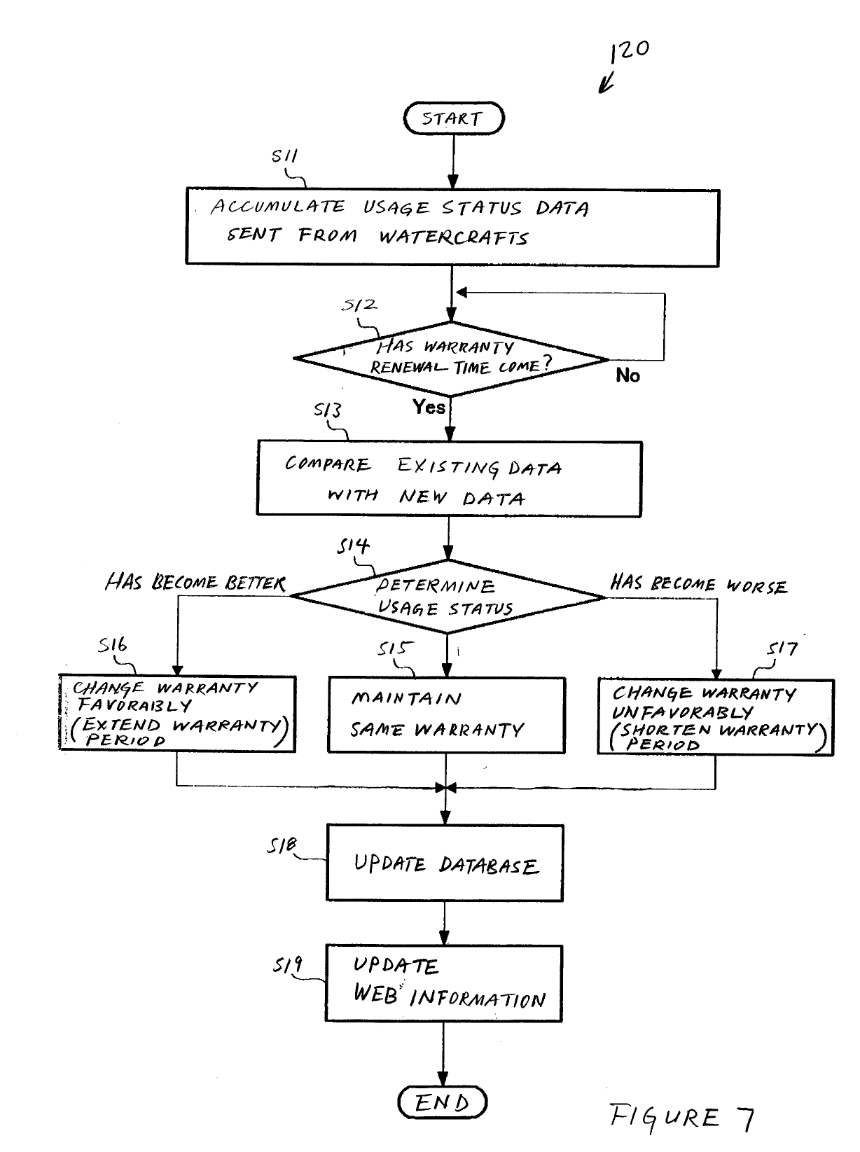

With reference to FIG. 7, a control routine that can be run by the server 34 is described below.

The warranty management program, which is part of the control program, preferably creates a database in which warranty periods covering the components or parts of each watercraft 30 in accordance with the usage status data are recorded. For example, an initial warranty period is two years for the outboard drive 32, three years for the hull of the watercraft 30 and one year for the fish-finder. The warranty management program can be configured to extend a warranty periods or reduce a maintenance fee if the watercraft owner keeps the watercraft 30 and/or the outboard drive 32 in good condition. Additionally, the warranty management program can be configured to penalize the owner by, for example but without limitation, reducing warranty coverage or increasing a maintenance fee.

The control routine 120 illustrated in FIG. 7 is configured to determine whether the subject watercraft has been properly maintained. Additionally, the control routine 120 can be configured to determine whether the warranty conditions regarding the subject watercraft have been satisfied. Further, the routine 120 can be configured to determine whether or not the corresponding warranty can be expanded or reduced based on the data regarding the maintenance of the subject watercraft.

The routine 120 starts and proceeds to step S11. At the step S11, usage status data from the watercraft 30 is accumulated. For example, the server 34 (FIG. 1) accumulates usage status data from the watercraft 30, as described above. The accumulation of the usage data status can be performed when the data is sent from the watercraft 30. After the step S11, the routine 120 advances to a step S12.

At the step S12, it is determined whether it is time to renew the warranty of the watercraft 30. For example, the server 34 can be configured to compare the current date with a predetermined warranty renewal date set. If the current date is prior to the predetermined warranty renewal date, the routine 120 returns and repeats the step S12. However, if the current date is equal to or subsequent to the predetermined warranty renewal date, the routine 120 moves on to a step S13.

At the step S13, the usage status data accumulated in the step S11 is compared with previously stored data. For example, the first instance that the routine 120 runs for a particular warranty, predetermined data can be compared with the usage status data accumulated from a subject watercraft. The predetermined data can correspond to a reference level of compliance with operational recommendations and maintenance recommendations. Subsequently, when the routine 120 is again run for the same subject watercraft, the newly accumulated usage data status is compared with usage data status from a previous instance that the step S13 is performed, the updating of which is described below in further detail. After the step S13, the routine 120 advances to a step S14.

At the step S14, it is determined whether the comparison performed in the step S13 indicates that the usage status data accumulated in the step S11 indicates that the subject product has been operated and maintained in accordance with the reference level of compliance with recommended operating and maintenance procedures. If, at the step S14, it is determined that the subject product has been operated and maintained in accordance with the reference level of compliance, the routine 120 moves on to a step S15.

At the step S15, the routine 120 indicates that the existing warranty conditions should be maintained. After the step S15, the routine 120 advances to a step S18.

At the step S18, the usage status data accumulated in the step S11 is saved to a database to be used as “existing data,” in the step S13 for the next instance at which the routine 120 is run. After the step S18, the routine 120 moves on to a step S19.

At the step S19, a database for storing information regarding the subject watercraft is updated. For example, the database can be maintained on the server 34 for access by authorized users via the internet. The database can include information regarding the status of the warranty covering the subject watercraft 30. Additionally, the database can be configured to display usage status data regarding the subject watercraft 30. For example, but without limitation, the database can be configured to display, for authorized users, the saved usage status data as a result of the last update, or a history of all the usage status data accumulated by the server 34.

With reference to the step S14, if it is determined that the subject product has not been operated and maintained in accordance with a reference level of compliance, the routine 120 moves to a step S17.

At the step S17, the routine 120 indicates that the existing warranty conditions should be reduced. For example, the duration of the warranty can be reduced, or a maintenance fee can be increased. After the step S17, the routine moves on to the steps S18 and S19 as described above.

Referring again to the step S14, if it is determined that the subject product has been operated and maintained in a manner exceeding that of the reference level of compliance, the routine 120 advances to a step S16.

At the step S16, the routine 120 indicates that the existing warranty conditions should be enhanced. For example, the duration of the warranty can be extended, and/or a maintenance fee can be reduced. After the step S16, the routine 120 advances to the steps S18 and S19 as described above.

Preferably, the system 36 is configured to receive usage status data from a plurality of watercraft regarding one or a plurality of warranties covering the watercraft and/or its constituent components. The server 34, i.e., the host computer, can trace the treatment of each watercraft after the watercraft was sold. The watercraft seller thus can provide each owner of the watercraft with substantially equitable warranty on the basis of the treatment.

The customers, dealers, watercraft builders and other persons or companies who have the user ID and the passwords can access the warranty conditions and/or the usage status data stored on the Internet at any time. The customers can use the information to improve their own treatment of their watercraft. Also, the dealers and watercraft builders can refer to the watercraft/outboard drive status when performing maintenance services. Other various usage's of the information and data can be provided for the skilled people in the field.

Various service conditions other than the warranty conditions can be provided using the management system. For example, the watercraft seller can offer some discount in the purchase of a new watercraft by the customer based upon past usage status data. Also, the watercraft seller can invite a customer to a special trade show based upon the usage status data.

The programs or software such as the routine 120, the collection practice program applied for the terminal computer at the watercraft and the control program of the control device can be recorded in media such as a floppy disc or a compact disc or can be transferred through the Internet. Any conventional computer can be used to read the programs recorded in the media or to download tem from the Internet.

The server, the terminal computers and the control device can be a distinctive device or a system or assembly combining multiple units. The multiple units can be either physically proximately positioned or separately positioned and connected through a network. The term “computer” in this description means not only the computer in the narrow sense but also all the processors, information processing equipment, microcomputers, machines and devices that can realize the functions of this invention with a program or programs.

The watercraft owner operator can conduct diagnoses on the watercraft and/or outboard drive using the intranet system periodically or prior to or after the cruising of the watercraft. The control device 76 or the computer 110 can collect diagnostic date through the intranet system 56 as part of the operational status data. Such diagnoses are disclosed in co-pending U.S. applications, titled DIAGNOSIS SYSTEM FOR WATERCRAFT, attorney docket number is FS.20066USOA, and DIAGNOSIS SYSTEM FOR WATERCRAFT, attorney docket number is FS.20067USOA, entire contents of which are hereby expressly incorporated by reference.

Of course, the foregoing description is that of preferred management system and method having certain features, aspects and advantages in accordance with the present invention. Various changes and modifications also may be made to the above-described management systems and method without departing from the spirit and scope of the invention, as defined by the claims.

What is claimed is:

1. A warranty management system for watercraft having a propulsion device and a plurality of sensors configured to detect operational states of the propulsion device, the system comprising, a controller configured to collect operational data from the sensors, the controller comprising a memory for storing the operational data as well as maintenance data entered from an owner of the watercraft and maintenance data entered by a professional maintenance service provider, a server, a communication device configured to transmit all of the stored data to the server, the server being configured to store the data from the controller and to adjust a warranty covering the watercraft based on the data from the controller.

2. A management system for a watercraft comprising a network, a plurality of terminal computers joining the network, a data collecting apparatus configured to collect usage status data regarding the watercraft and to provide the network with the data, the data being available at at least one of the terminal computers.

3. The management system as set forth in claim 2, wherein the usage status data includes operational status data of the watercraft collected at each use of the watercraft.

4. The management system as set forth in claim 3, wherein the watercraft is propelled by a propulsion device, the propulsion device is powered by an internal combustion engine, the operational status data includes either operational status data of the propulsion device or operational status data of the engine.

5. The management system as set forth in claim 4, wherein the propulsion device includes a transmission shift mechanism configured to shift the propulsion device among forward, reverse and neutral positions, the operational status data of the propulsion device includes data as to the status of the shift mechanism.

6. The management system as set forth in claim 5 additionally comprises an actuator configured to actuate the shift mechanism, and a control device configured to control the actuator, the control device being configured to accumulate control data of the actuator, the data collecting device being configured to collect the control data at least as part of the operational status data.

7. The management system as set forth in claim 5, wherein the engine includes a throttle mechanism configured to regulate at least an amount of air delivered to a combustion chamber of the engine, the operational data of the engine includes data as to the status of the throttle mechanism.

8. The management system as set forth in claim 7 additionally comprises a first actuator configured to actuate the shift mechanism, a second actuator configured to actuate the throttle mechanism, and a control unit configured to control the first and second actuators, the control unit being configured to accumulate control data of the first and second actuators, the data collecting device being configured to collect the control data at least as part of the operational status data.

9. The management system as set forth in claim 4, wherein the engine includes a throttle mechanism configured to regulate at least an amount of air delivered to a combustion chamber of the engine, the operational data of the engine including data regarding the status of the throttle mechanism.

10. The management system as set forth in claim 9 additionally comprising an actuator configured to actuate the throttle mechanism, and a control device configured to control the actuator, the control device being configured to accumulate control data of the actuator, the data collecting device being configured to collect the control data at least as part of the operational status data.

11. The management system as set forth in claim 4 additionally comprising at least one sensor configured to detect a condition of either a component of the watercraft, a component of the propulsion device, and a component of the engine, wherein the data collecting device collects an output of the sensor at least as part of the operational status data.

12. The management system as set forth in claim 2, wherein the watercraft is propelled by a propulsion device, the propulsion device being powered by an internal combustion engine, the usage status data including maintenance data based upon a maintenance service performed on a component of the watercraft, a component of the propulsion device, or a component of the engine.

13. The management system as set forth in claim 2 additionally comprising a host computer connected to the network, the host computer accumulating the usage status data.

14. The management system as set forth in claim 13, wherein the host computer controls access to the usage status data by the terminal computer.

15. The management system as set forth in claim 13, wherein the host computer replaces the usage status data with the newly collected usage status data.

16. The management system as set forth in claim 13, wherein the host computer is configured to determine whether the usage status data are different from the previously collected usage status data, and to establish service condition data of the watercraft based upon the determination.

17. The management system as set forth in claim 2, wherein the data collecting device communicates with the network by radio.

18. The management system as set forth in claim 2, wherein the network is the Internet.

19. A management system for a plurality of watercraft comprising a network, a host computer connected to the network, a plurality of terminal computers connected to the network, the host computer being configured to manage service condition data of each one of the watercraft, the host computer being configured to collect fundamental data regarding each one of the watercraft, the host computer also being configured to determine whether the fundamental data are different from fundamental data previously collected, the host computer also being configured to establish service condition data of each one of the watercraft based upon the determination.

20. The management system as set forth in claim 19, wherein the service condition data include warranty condition data.

21. The management system as set forth in claim 20, wherein the warranty condition data includes warranty period data.

22. The managing system as set forth in claim 19 additionally comprising a data collecting device collecting the fundamental data regarding each one of the watercraft, the data collecting device being configured to provide the network with the fundamental data, the host computer obtaining the fundamental data through the network.

23. A method for managing data regarding a watercraft comprising collecting data regarding the watercraft, providing a network with the data, accumulating the data at a host computer connected to the network, and selectively authorizing access to a user at a terminal computer connected to the network.

24. The management method as set forth in claim 23, wherein collecting data regarding the watercraft comprises collecting operational status data of the watercraft at each use of the watercraft.

25. The management method as set forth in claim 23 additionally comprising performing a maintenance procedure on at least one of a component of the watercraft, a component of a propulsion device propelling the watercraft, and a component of an engine powering the propulsion device, the data being collected at the time of the maintenance procedure.

26. The management method as set forth in claim 23 additionally comprising determining whether the collected data are different from previously collected data, establishing service condition data of the watercraft based upon the determination, and providing the network with the service condition data.

27. A method for managing data regarding a plurality of watercraft comprising collecting fundamental data regarding each one of the watercraft at a host computer connected to a network, determining whether the fundamental data are different from fundamental data previously collected, and establishing service condition data of each one of the watercraft based upon the determination.

28. The management method as set forth in claim 27, wherein the service condition data include warranty condition data.
